(19) United States
(12) Patent Application Publication
(10) Pub. No.: US 2025/0245333 A1
(43) Pub. Date: Jul. 31, 2025

(54) Extended Embedded Controller Authenticated BIOS Interface for Analysis of Firmware Variable Transactions

(71) Applicant: Dell Products L.P., Round Rock, TX (US)

(72) Inventors: Shekar Babu Suryanarayana, Bangalore (IN); Karunakar Poosapalli, Bangalore (IN); Shrirathna K G, Udupi (IN)

(21) Appl. No.: 18/422,967

(22) Filed: Jan. 25, 2024

(51) Int. Cl. G06F 21/57; G06F 21/44

(52) U.S. Cl. CPC G06F 21/572; G06F 21/44; G06F 2221/033

(57) ABSTRACT

A firmware management operation. The firmware management operation includes providing an information handling system with a distributed BIOS, the distributed BIOS including a BIOS component and a BIOS variable, the BIOS variable being stored within a firmware variable non-volatile memory store; instantiating a firmware variable transaction; and, authenticating, via a secure authenticated BIOS interface, the firmware variable transaction.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed BIOS, the distributed BIOS including a BIOS component and a BIOS variable, the BIOS variable being stored within a firmware variable non-volatile memory store; instantiating a firmware variable transaction; and, authenticating, via a secure authenticated BIOS interface, the firmware variable transaction.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed BIOS, the distributed BIOS including a BIOS component and a BIOS variable, the BIOS variable being stored within a firmware variable non-volatile memory store; instantiating a firmware variable transaction; and, authenticating, via a secure authenticated BIOS interface, the firmware variable transaction.

In another embodiment the invention relates to a computer-readable storage medium embodying computer program code, the computer program code comprising computer executable instructions configured for: providing an information handling system with a distributed BIOS, the distributed BIOS including a BIOS component and a BIOS variable, the BIOS variable being stored within a firmware variable non-volatile memory store; instantiating a firmware variable transaction; and, authenticating, via a secure authenticated BIOS interface, the firmware variable transaction.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 is a simplified block diagram showing a firmware variable management environment;

FIG. 6 is a simplified block diagram showing firmware variable management architecture;

FIG. 7 is a process flow of a secured shadow protocol operation; and,

FIG. 8 is a simplified block diagram showing a secured advanced configuration and power interface variable memory store operation.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the present disclosure include an appreciation that firmware such as BIOS can have a plurality of non-volatile store regions within an information handing system. Various aspects of the present disclosure include an appreciation that these non-volatile store regions can include an advanced configuration and power interface (ACPI) storage region, a serial peripheral interface (SPI) flash memory storage region, a SPI flash non-volatile random access memory (NVRAM) storage region, a platform controller hub (PCH) storage region, etc. Various aspects of the present disclosure include an appreciation that these non-volatile storage regions can be used for storing platform hardware configuration information, platform software configuration information as well as customer keys or configuration information and vendor keys and configuration information. Various aspects of the present disclosure include an appreciation that these non-volatile storage regions can store device configurations, firmware settings, and other information that is used during a pre boot phase and passed to an operation system and vice versa. Various aspects of the present disclosure include an appreciation that firmware non-volatile store regions are common and accessible by all firmware components as well as other information handling system components and applications.

Various aspects of the present disclosure include an appreciation that a compromised non-volatile storage region can include vulnerable and/or junk variables which can corrupt the firmware thus causing boot failure, update failure, power on self test (POST) issues, other power on issues, any of which can to motherboard replacement. Various aspects of the present disclosure include an appreciation that device path-based non-volatile memory access is not presently available. Various aspects of the present disclosure include an appreciation that corruption or blocked writes in boot important data non-volatile memory stores can prevent recovery or remediation, possibly leaving no traceable telemetry events for issue resolution.

Various aspects of the present disclosure include an appreciation that without an end-to-end event solution, detecting early variable faults caused by other firmware or devices becomes challenging. Various aspects of the present disclosure include an appreciation that compromised administration privilege can allow hackers to decode variable names as well as global unique identifier (GUID) variables, potentially leading to corruption of important firmware variables and subsequent boot failures. Various aspects of the present disclosure include an appreciation that non-volatile storage space can be filled due to continuous vulnerable writes with unique GUID variables, potentially causing failures in writing, unexpected behavior, degraded system performance, and delayed boot due to space constraints, prolonged cleanup activity, or a combination thereof.

Various aspects of the present disclosure include an appreciation that known systems do not have access to versioned cloud synchronization of platform non-volatile storage information. Various aspects of the present disclosure include an appreciation that without versioned cloud synchronization, it is challenging to restore an information handling system with stable non-volatile store data to enable boot. Various aspects of the present disclosure include an appreciation that versioned cloud synchronization can assist with update, recovery or restore of a golden configuration of customer settings. Various aspects of the present disclosure include an appreciation that cloud synchronization can assist with enabling only genuine write into non-volatile storage locations for distributed vulnerability control across a plurality of system designs.

Various aspects of the present disclosure include an appreciation that it is known to use encrypted NVRAM variables; however, this protection only applies to the variable data. Additionally, it is possible for a hacker to overwrite the encrypted variable offset with malware content, which can result in POST failures. Various aspects of the present disclosure include an appreciation that known non-volatile memory store solutions can suffer from a serviceability gap.

A system and method are disclosed for providing a firmware variable management operation for non-volatile firmware variable memory storage locations. In certain embodiments, the firmware variable management operation includes providing an embedded controller with an authenticated BIOS interface for analysis of firmware variable transactions. In various embodiments, firmware variable transactions can include writing to firmware variable non-volatile memory stores, reading from firmware variable non-volatile memory stores, modifying firmware variable contained within firmware variable non-volatile memory stores, analyzing firmware variable contained within firmware variable non-volatile memory stores, or a combination thereof. In various embodiments, the firmware variable management operation assists with system diagnostics, monitoring of security activities, system performance measurements, firmware issue analysis, etc.

In certain embodiments, the firmware variable management operation includes an authenticated BIOS interface operation. In certain embodiments, an embedded controller is extended to include a secure authenticated BIOS interface (ABI). In certain embodiments, the embedded controller provides a root of trust for dynamic authorization and measurement of non-volatile storage variables. In certain embodiments, the extended embedded controller provides high security based non-volatile memory storage access and creates a runtime trusted domain for boot variable access, including processor environment boot variable access and platform boot variable access.

In certain embodiments, the firmware variable management operation implements a trusted shadowing protocol which provides device path-based authorization for non-volatile memory variable access. In certain embodiments, the trusted shadowing protocol control corruptions with any genuine writes. In certain embodiments, the trusted shadowing protocol provides authenticated variable services. In certain embodiments, the trusted shadowing protocol enables end-to-end monitoring of the non-volatile variable access and protects the various firmware non-volatile memory stores. In certain embodiments, the trusted shadowing protocol implements seamless variable telemetry services which assist information handling system providers and processor environment providers to generate a boot history as well as customer configuration, change patterns and associated hardware behavior.

In certain embodiments, the firmware variable management operation implements a simulated non-volatile memory variable storage location operation which provides a simulated non-volatile memory storage environment. In certain embodiments, the simulated non-volatile memory storage location operation enables a cloud based non-volatile memory ecosystem. In certain embodiments, the cloud based non-volatile memory ecosystem may be used to provide machine learning-based non-volatile memory storage location access control. In certain embodiments, the firmware management operation implements a simulated non-volatile memory storage location operation which uses the simulated non-volatile memory storage environment to categorize the non-volatile memory variables. In certain embodiments, the non-volatile memory variables may be characterized as trusted by associating a trusted value (e.g., TRUSTED_VAR) with the variable or untrusted by associating an untrusted value (e.g., UNTRUSTED_VAR) with the variable. In certain embodiments, the characterization of the variables may be added to respective variable lists. In certain embodiments, the simulated non-volatile memory storage environment includes a platform non-volatile memory variable golden configuration. In certain embodiments, the platform non-volatile memory variable golden configuration may be used to provide cloud synchronization to restore to last known stable boot configuration data.

In certain embodiments, the firmware variable management operation implements a processor exception handler protocol. In certain embodiments, the processor exception handling protocol dynamically re-initializes an interrupt vector table (IVT), a boot thin network stack, or a combination thereof. In certain embodiments, the processor exception handling protocol dynamically re-initializes the IVT, the boot thin network stack, or a combination thereof using an exception handler memory map to reboot the platform in a safe mode of operation. In certain embodiments, the safe mode of operation holds the platform in the safe mode of operation using a reset vector. In certain embodiments, the processor exception handling protocol performs a cloud synchronization using a known good (e.g., a golden) firmware configuration which can thus enable an operating system boot.

Such a system and method advantageously facilitate firmware data management. In various embodiments, firmware data management includes system diagnostics, monitoring security activities, system performance measurements, remote system management, or a combination thereof.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

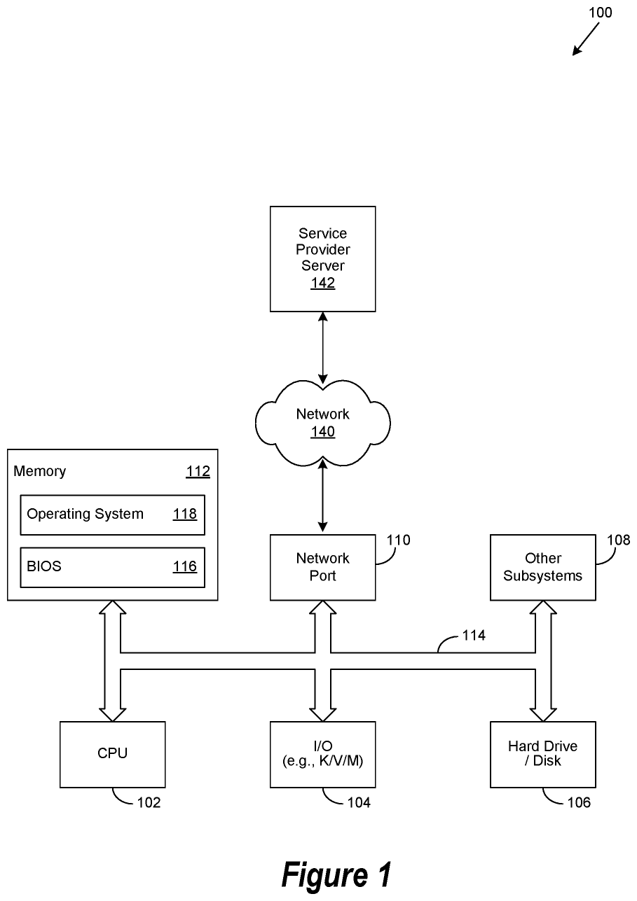

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS's 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS's 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS's 100 initialization and startup within an .efi file, rather than on its associated firmware. In typical implementations, the .efi file may be stored on a special memory partition known as an EFI System Partition (ESP), which also contains the IHS's 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In certain embodiments, the firmware management operation may be performed during operation of an IHS 100. In various embodiments, performance of the firmware management operation may result in the realization of improved operation of an IHS 100.

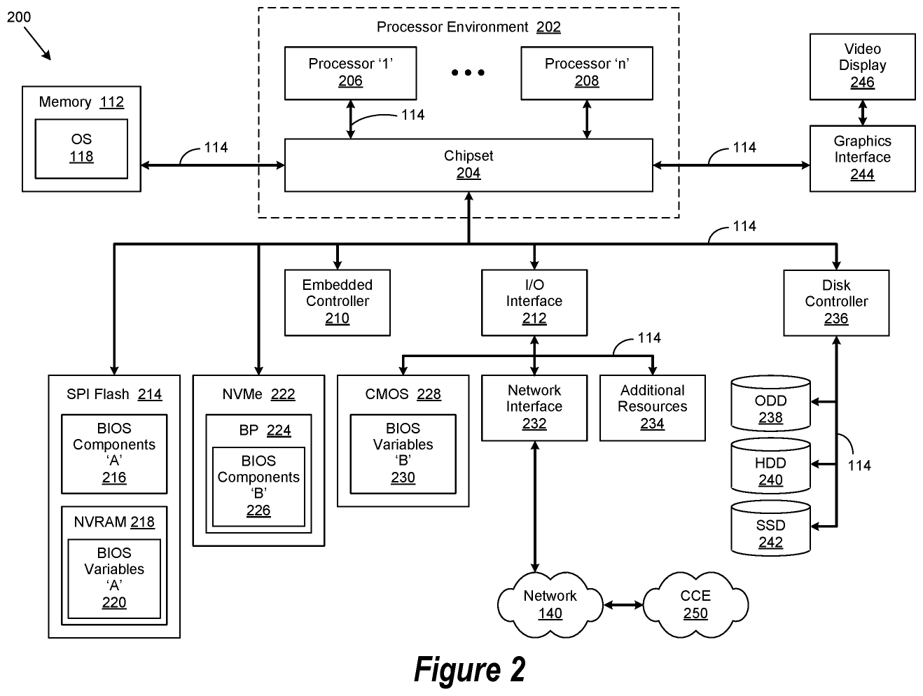

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics workstation, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft® Windows®, while processor ‘n’ 208 may be implemented to run a version of Linux®.

In various embodiments, one or more Pes 202 selected from a plurality of Pes 202 may be implemented within the multi-processor operating environment 200. In certain of these embodiments, a particular PE 202 selected from a plurality of Pes 202 may be vendor-specific. In various embodiments, a particular PE 202 selected from a plurality of Pes 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114. In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

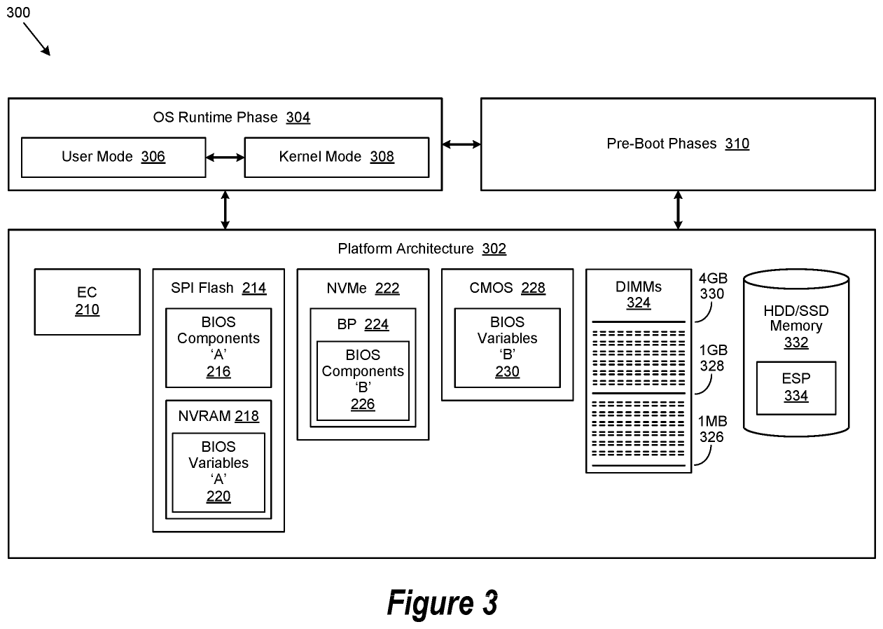

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel®, AMD®, Qualcom®, Broadcom®, Nvidia®, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, Serial Peripheral Interface (SPI) Flash 214 memory, Nonvolatile Memory Express (NVMe) 222 memory, and a complementary metal-oxide-semiconductor (CMOS) 228 chip, or a combination thereof, as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1 GB 328 to 4 GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS's that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

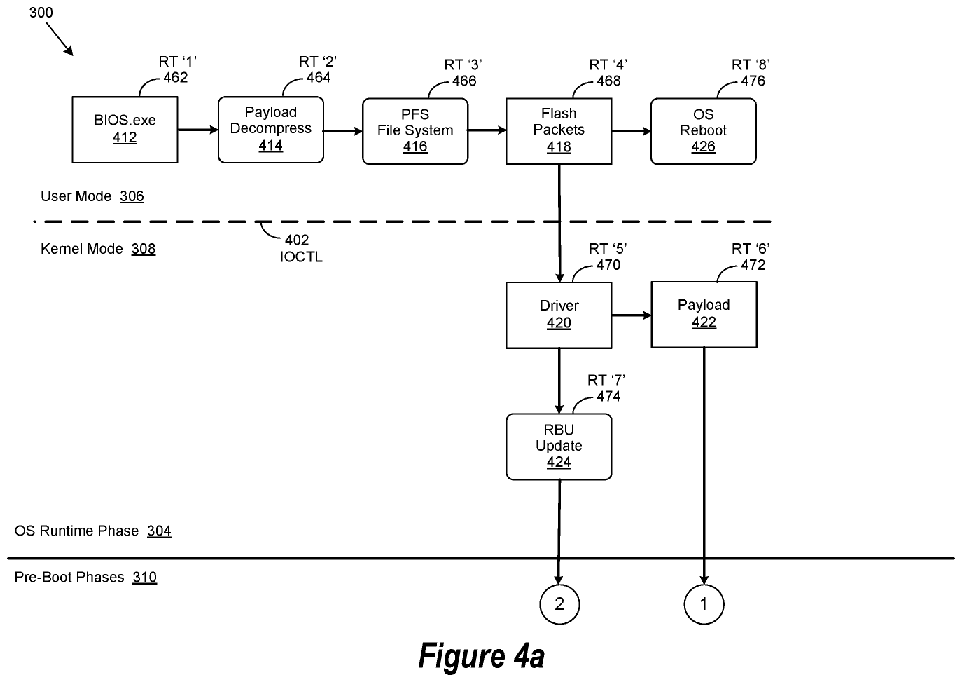

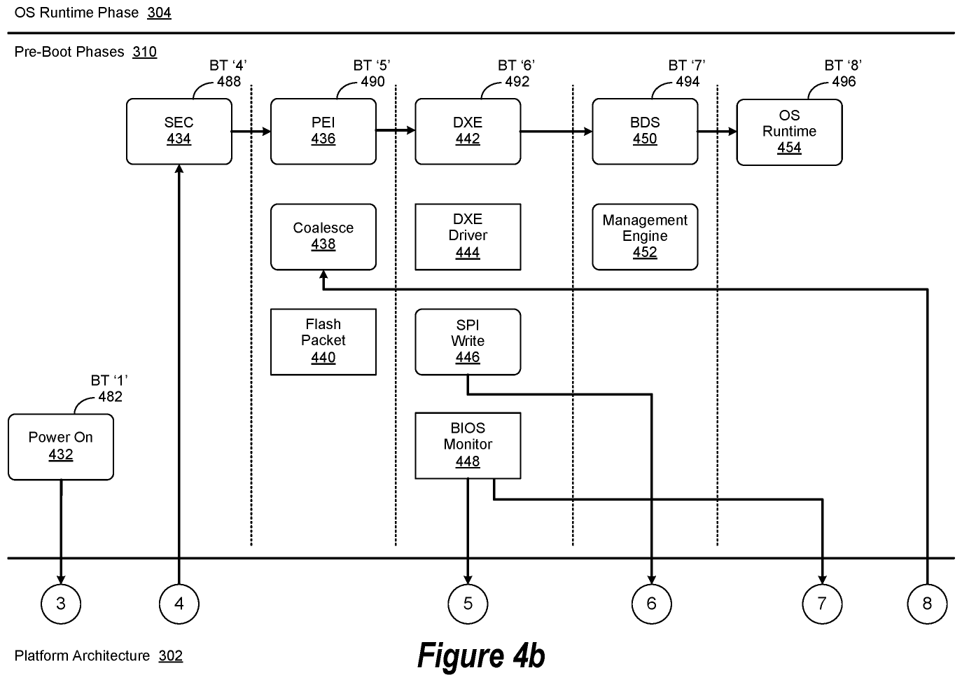

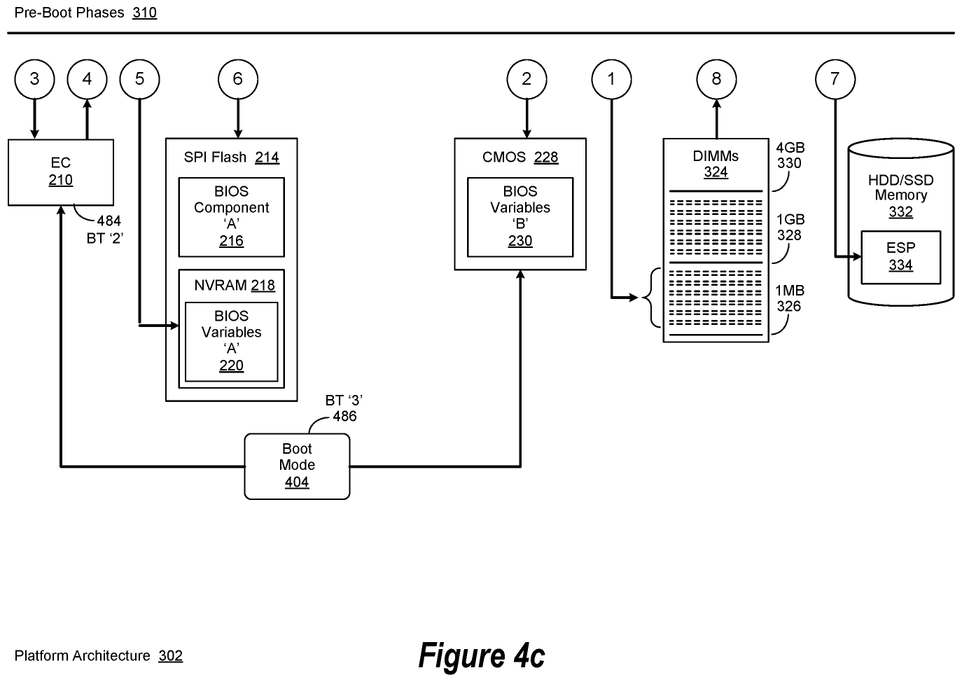

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system's (IHS's) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6′ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more DXE drivers 444. In general, the DXE Core component is responsible for producing a set of boot services, DXE services, and RT Services. Likewise, the DXE Dispatcher component is responsible for discovering and executing DXE drivers 444 in the correct order. In turn, the DXE drivers 444 are responsible for initializing the IHS's processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell® Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel® Corporation of Santa Clara, California, may be implemented to use the selected boot device in BT step ‘8’ 496 to boot the ASDFMP 300 into an OS runtime 454 state.

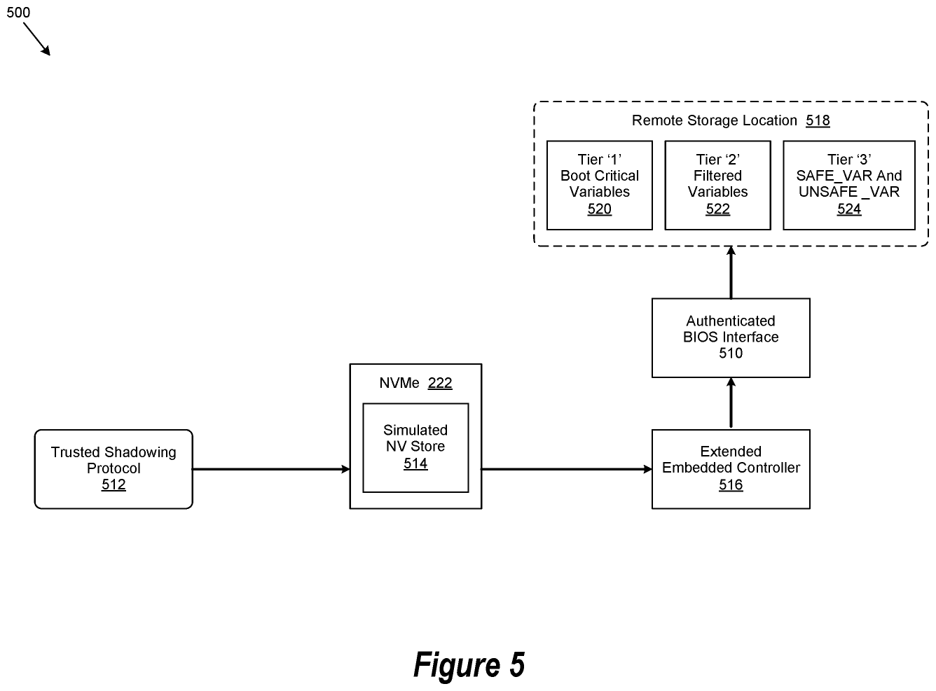

Referring to FIG. 5 a simplified block diagram a firmware variable management environment 500 is shown. In certain embodiments, the firmware variable management environment 500 performs a firmware variable management operation. As used herein, a firmware variable management operation broadly refers to a firmware management operation, described in greater detail herein, performed directly, or indirectly, within a multi-processor operating environment to store, retrieve, aggregate, disaggregate, add, delete, modify, revise, update, replace, or restore one or more firmware variables. In various embodiments, some or all of the one or more firmware variables include respective BIOS variables.

In various embodiments, the firmware variable management environment 500 includes an authenticated BIOS interface module 510, a trusted shadowing protocol module 512, a simulated non-volatile memory variable storage location module 514, an extended embedded controller module 516, a remote storage location 518 or a combination thereof. In certain embodiments, the authenticated BIOS interface module 510 performs an authenticated BIOS interface operation. In certain embodiments, the trusted shadowing protocol module 512 performs trusted shadowing protocol operation. In certain embodiments, the simulated non-volatile memory variable storage location module 514 performs a simulated non-volatile memory variable storage location operation. In certain embodiments, the extended embedded control 516 performs root of trust operation. In certain embodiments, the remote storage location 518 includes a plurality of tiered storage locations 520, 522, 524 (Tier 1, Tier 2, Tier 3).

As used herein, an authenticated BIOS interface operation broadly refers to a firmware variable management operation, described in greater detail herein, performed directly, or indirectly, within a multi-processor operating environment to authenticate a firmware variable transaction. As used herein, a trusted shadowing protocol operation broadly refers to a firmware variable management operation, described in greater detail herein, performed directly, or indirectly, within a multi-processor operating environment to provide a device path based authorization of a firmware variable transaction. As used herein, a simulated non-volatile memory variable storage location operation broadly refers to a firmware variable management operation, described in greater detail herein, performed directly, or indirectly, within a multi-processor operating environment to generate a simulation of a non-volatile memory variable storage location.

As used herein, a root of trust operation broadly refers to a firmware variable management operation, described in greater detail herein, performed directly, or indirectly, within a multi-processor operating environment to provide a root of trust by leveraging a secure interface to ensure integrity and security of communication between components when performing a firmware variable transaction. In certain embodiments, an embedded controller is extended to provide a root of trust function. As used herein, a root of trust broadly refers to a highly reliable component that performs specific, important security functions. A root of trust component is a building block upon which other components can derive security functions.

In certain embodiments, the root of trust operation uses a secure authenticated BIOS interface to extend the embedded controller 516 of the information handling system to function as a root of trust. In certain embodiments, the embedded controller 516 includes a root of trust component. In certain embodiments, the extended embedded controller 516 may be used to provide for dynamic authorization and measurement of firmware variables. In certain embodiments, the root of trust operation leverages a secure interface of the embedded controller to ensure the integrity and security of data communication between components of the information handling system. By extending the embedded controller as the root of trust, the root of trust operation can dynamically authorize access to firmware variables such as non-volatile store firmware variables. Additionally, the root of trust operation enables measurement of these firmware variables, ensuring that their values haven't been modified without authorization. The root of trust operation enhances the security and trustworthiness of the system by tightly controlling access to sensitive data stored in the non-volatile memory storage locations.

In certain embodiments, the trusted shadowing protocol operation implements a trusted shadowing protocol. In certain embodiments, the trusted shadowing protocol operation provides authenticated services for firmware variables such as non-volatile store firmware variables. In certain embodiments, the trusted shadowing protocol implements a supervised firmware protocol which provides end-to-end telemetry variable services. In certain embodiments, the supervised firmware protocol monitors and protects firmware variables such as non-volatile store firmware variables. In certain embodiments, the trusted shadowing protocol operation implements seamless variable telemetry services which assist information handling system providers and processor environment providers to generate a boot history as well as customer configuration, change patterns and associated hardware behavior.

In certain embodiments, the trusted shadowing protocol operation uses the shadow protocol to identify device path-based variable stores. In certain embodiments, the trusted shadowing protocol operation uses the shadow protocol to identify firmware access mechanism stores. In certain embodiments, the trusted shadowing protocol operation provides a runtime method to detect variable service access from external firmware providers such as the trusted computing group (TCG), binaries etc.

In certain embodiments, the trusted shadowing protocol operation enables system provider custom variable services to detect and authenticate the calling module for any non-volatile store firmware variable access, modification, or a combination thereof. In certain embodiments, the trusted shadowing protocol includes non-volatile store firmware variable associated information. In certain embodiments, the non-volatile store firmware variable associated information includes GUID information, variable name information, caller information, or a combination thereof. In certain embodiments, the caller information includes a device path, a type, an access level, an access type, or a combination thereof.

In certain embodiments, the trusted shadowing protocol operation implements a trusted shadowing protocol runtime driver which authenticates a non-volatile store firmware variable access, modification, or a combination thereof. In certain embodiments, the trusted shadowing protocol runtime driver registers the respective firmware event. In certain embodiments, the trusted shadowing protocol generates an event database table. In certain embodiments, the event database table logs entries for respective firmware events.

In certain embodiments, the simulated non-volatile memory variable storage location operation implements a simulated non-volatile memory variable storage environment. In certain embodiments, the simulated non-volatile memory storage location operation enables a cloud based non-volatile memory ecosystem. In certain embodiments, the cloud based non-volatile memory ecosystem may be used to provide machine learning-based non-volatile memory storage location access control. In certain embodiments, the firmware management operation implements a simulated non-volatile memory storage location operation which uses the simulated non-volatile memory storage environment to categorize the non-volatile memory variables. In certain embodiments, the non-volatile memory variables may be characterized as trusted by associating a trusted value (e.g., TRUSTED_VAR) with the variable or untrusted by associating an untrusted value (e.g., UNTRUSTED_VAR) with the variable. In certain embodiments, the characterization of the variables may be added to respective variable lists.

In certain embodiments, machine learning techniques are applied to analyze and understand the patterns of access and usage of non-volatile memory firmware variables. This learning-based approach develops and refines non-volatile memory firmware access control strategies that adapt and evolve based on observed behaviors, enhancing the security and efficiency of non-volatile memory firmware store access controls.

In certain embodiments, the simulated non-volatile memory storage environment includes a platform non-volatile memory variable golden configuration. In certain embodiments, the platform non-volatile memory variable golden configuration may be used to provide cloud synchronization to restore to last known stable boot configuration data.

In certain embodiments, the firmware variable management operation includes a dynamic re-initialization operation. In certain embodiments, the dynamic re-initialization operation uses an exception handler to perform a cloud synchronization to restore to a last known stable boot configuration data. In certain embodiments, the dynamic re-initialization operation dynamically re-initializes an interrupt vector table. In certain embodiments, the interrupt vector table is re-initialized to include exception vectors. In certain embodiments, the exception vectors include supplier specific exception vectors. In certain embodiments, the interrupt vector table is actively re-initialized in the background when the information handling system is executing in a no POST/no video (NP/NV) mode of operation. In certain embodiments, the exception handler saves the firmware events into different non-volatile memory stores. In certain embodiments, the exception handler forces the information handling system into different boot modes during re-initialization. In certain embodiments, the exception handling automatically exports the system events and telemetry logs when the information handling system is executing in a NP/NV mode of operation.

In certain embodiments, the firmware variable management operation includes a firmware telemetry operation. In certain embodiments, the firmware telemetry operation provides seamless firmware telemetry and event abstraction. In certain embodiments, the firmware telemetry operation executes a runtime demon module. In certain embodiments, the runtime demon module includes telemetry to provide services which detect security attacks or suspicious boot activities or threats from any other firmware or devices. In certain embodiments, the runtime demon module includes telemetry to help improve firmware security. In certain embodiments, the runtime demon module includes telemetry to provide an enhanced firmware security assessment. In certain embodiments, the runtime demon module includes telemetry to manage system performance.

In certain embodiments, the firmware telemetry operation forces the system into a boot mode which loads a PEI stack to execute a PEI pre-boot phase and initialize the information handling system. In certain embodiments, the firmware telemetry operation initializes a thin network stack. In certain embodiments, the thin network stack executes network protocol. In certain embodiments, the network protocol includes a universal network driver interface (UNDI), a simple network protocol (SNP), a managed network protocol (MNP), or a combination thereof. In certain embodiments, the thin network stack enables the information handling system to share the system log over a network.

In certain embodiments, the firmware telemetry operation export events data from one or more non-volatile memory stores. In certain embodiments, the events data includes historical data which can be used in firmware analysis to avoid future risks or bugs. In certain embodiments, the events data can be used to provide preemptive firmware updates, preemptive recoveries, or a combination thereof.

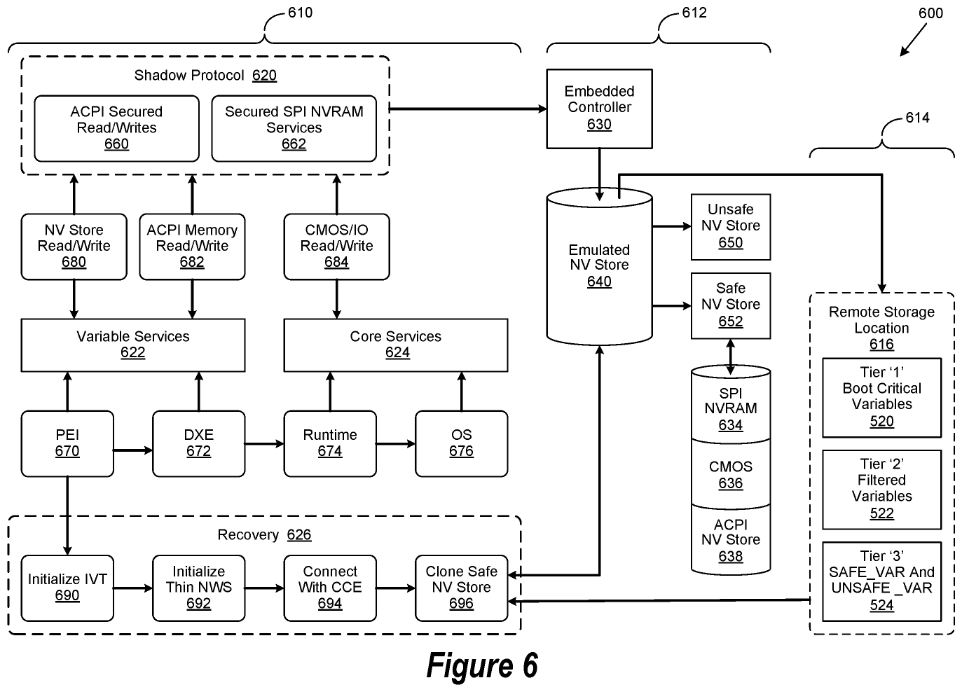

Referring to FIG. 6, a simplified block diagram a firmware variable management architecture 600 is shown. More specifically, the firmware variable management architecture 600 includes a BIOS portion 610, a component portion 612 and a recovery data portion 614. In certain embodiments, the recovery data portion 614 includes a plurality of tiered storage locations 616 (Tier 1, Tier 2, Tier 3).

The BIOS portion 610 includes a shadow protocol module 620, a variable services module 622, a core services module 624, a recovery module 626, or a combination thereof. The component portion 612 includes an embedded controller 630, a plurality of non-volatile memory variable stores 634, 636, 638, a emulated von volatile memory store component 640, a plurality of composite firmware stores 650, 652, or a combination thereof. In certain embodiments, the plurality of non-volatile memory variable stores 634, 636, 638 include a SPI NVRAM variable store, a CMOS variable store, an ACPI variable store, or a combination thereof. In certain embodiments, the plurality of composite firmware stores 650, 652, include a safe composite firmware store, an unsafe composite firmware store or a combination thereof.

In certain embodiments, the shadow protocol module 620 includes an ACPI secured read/write module 660, a secured SPI NVRAM services module 662, or a combination thereof. In certain embodiments, the variable services module 622 executes during a PEI phase 670, a DXE phase 672, or a combination thereof. In certain embodiments, the cores services module 624 executes during a runtime phase 674, an operating system phase 676, or a combination thereof.

In certain embodiments, the variable services module 622 communicates with the shadow protocol module 620 when performing non-volatile store read/write operations 680, ACPI variable store read/write operations 682, or a combination thereof. In certain embodiments, the core services module communicates with the shadow protocol module 620 when performing CMOS variable store read/write operations 684, IO read/write operations 684, or a combination thereof.

In certain embodiments, the recovery module 626 executes during a PEI phase 670, a DXE phase 672, or a combination thereof. In certain embodiments, the recovery module 626 includes a vector interrupt initialization component 690, a network services initialization component 692, a connection component 694, a clone component 696, or a combination thereof. In certain embodiments, the vector interrupt initialization component 690 initializes an interrupt vector table when performing a recovery operation. In certain embodiments, the network services initialization component initializes a thin network stack when performing a recovery operation. In certain embodiments, the connection component 694 connects the information handling system with a data recovery store. In certain embodiments, the data recovery store corresponds to the recovery data portion 614. In certain embodiments, the clone component 696 uses the recovered data to clone a safe non-volatile memory store (e.g., composite memory store 650).

In certain embodiments, the plurality of tiered storage locations 616 of the recovery data portion 614 includes a boot variable storage location (Tier 1), filtered variable storage location (Tier 2), a safe variable indication storage location (Tier 3), or a combination thereof. In certain embodiments, the recovery data portion 614 includes a remote storage location. In certain embodiments, the remote storage location is a cloud based storage location.

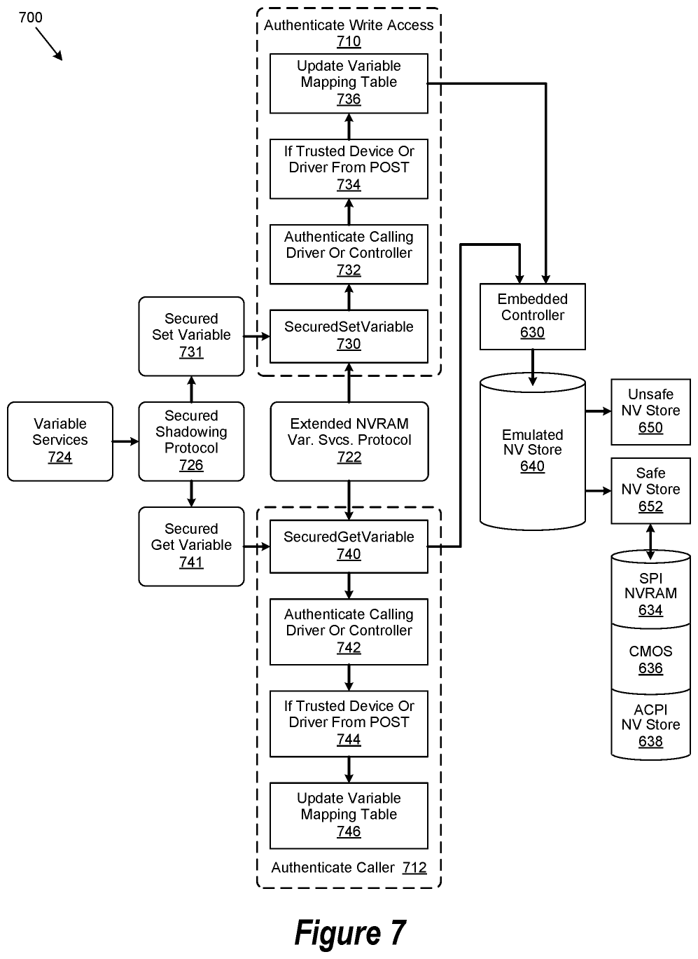

Referring to FIG. 7, a process flow of a secured shadow protocol operation 700 is shown. In certain embodiments, the secured shadow protocol operation performs a SPI NVRAM variable read/write operation. In certain embodiments, the secured shadow protocol operation 700 implements secured variable services for non-volatile memory get and set operations.

In certain embodiments, the secured shadow protocol operation 700 includes an authenticate write access portion 710, an authenticate caller portion 712, or a combination thereof. In certain embodiments, an extended non-volatile memory variable services protocol 722 is used to access, the authenticate write access portion 710, the authenticate caller portion 712, or a combination thereof. In certain embodiments, the extended non-volatile memory variable services protocol 720 is accessed by a variable services module 724, a secured shadow protocol 726, or a combination thereof.

More specifically, when the authenticate write access portion 710 is accessed, the secured shadow protocol operation 700 proceeds to step 730 where a secured variable 731 is set. In certain embodiments, the secured variable is retrieved via a SecuredSet Variable function call. Next at step 732, the authenticate write access portion 710 authenticates the calling driver or controller performing the variable retrieval. In certain embodiments, the driver or controller is authenticated with device path protocol information. Next at step 734, once authenticated, the authenticate write access portion 710 identifies the driver or controller as trusted. Next at step 734, when the driver or controller is trusted then the authenticate write access portion 710 updates a variable mapping table with the retrieved secured variable.

More specifically, when the authenticate caller portion 712 is accessed, the secured shadow protocol operation 700 proceeds to step 740 where a secured variable 741 is retrieved. In certain embodiments, the secured variable is retrieved via a SecuredGetVariable function call. Next at step 742, the authenticate write access portion 710 authenticates the calling driver or controller performing the get variable operation. In certain embodiments, the driver or controller is authenticated with device path protocol information. Next at step 744, once authenticated, the authenticate write access portion 710 identifies the driver or controller as trusted. Next at step 746, when the driver or controller is trusted then the authenticate write access portion 710 updates a variable mapping table with the retrieved secured variable.

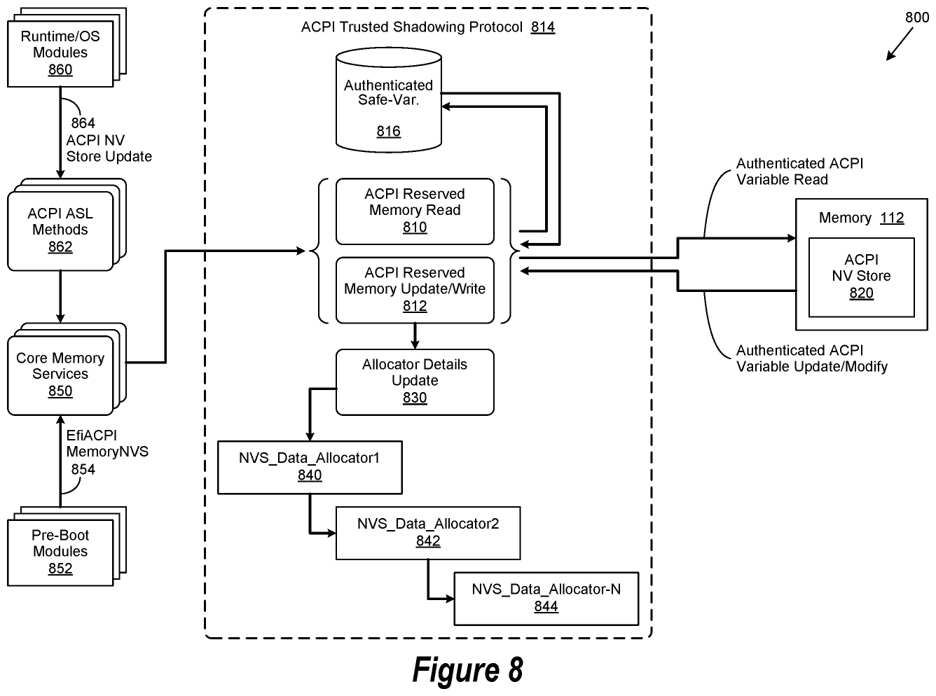

Referring to FIG. 8, a secured advanced configuration and power interface variable memory store operation 800 is shown. More specifically, when an ACPI reserved memory read operation 810 or an ACPI reserved memory update/write operation 812 is performed, the read or write is authenticated by the ACPI trusted shadowing protocol 814. In certain embodiments, when an ACPI reserved memory read operation 810 or an ACPI reserved memory update/write operation 812 is performed, an authenticated safe variable repository 816 is accessed.

When the ACPI reserved memory read operation 810 or the ACPI reserved memory update/write operation 812 are authenticated by the ACPI trusted shadowing protocol, an ACPI non-volatile memory store 820 is accessed. In certain embodiments, the ACPI non-volatile memory store 820 reads an authenticated ACPI variable. In certain embodiments, the non-volatile memory store 820 updates or modifies an authenticated ACPI variable. In certain embodiments, the ACPI non-volatile memory store 820 is maintained within a system memory of the information handling system.

Next, at step 830, an allocator details the update of the ACPI non-volatile memory store. In certain embodiments, the allocator includes a plurality of allocator entries 840, 842, 844, each of which can store respective information regarding the update of the ACPI non-volatile memory store.

In certain embodiments, when an ACPI reserved memory read operation 810 or an ACPI reserved memory update/write operation 812 is performed, core memory services 850 may be accessed. In certain embodiments, the core memory services 850 receive inputs from one or more pre-boot module 852. In certain embodiments, the inputs received from the one or more pre-boot modules 852 are provided via an EfiACPIMemoryNVS command 854. In certain embodiments, one or more runtime/OS modules 860 provide inputs to the core memory services 850. In certain embodiments, the runtime/OS modules 860 provide inputs via ACPI and ACPI source language (ASL) methods 862. In certain embodiments, the inputs provided to the ACPI and ACPI source language (ASL) methods 862 by the runtime/OS module 860 include ACPI non-volatile (NV) store updates.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed BIOS, the distributed BIOS including a BIOS component and a BIOS variable, the BIOS variable being stored within a firmware variable non-volatile memory store;
instantiating a firmware variable transaction; and,
authenticating, via a secure authenticated BIOS interface, the firmware variable transaction.

2. The method of claim 1, wherein:
the authenticating is performed by an embedded controller, the embedded controller providing the information handing system with a root of trust for the firmware variable transaction.

3. The method of claim 1, wherein:
the secure authenticated BIOS interface includes a trusted shadowing protocol, the trusted shadowing protocol implementing a device path based authorization for the firmware variable transaction.

4. The method of claim 1, further comprising:
generating a simulated non-volatile memory variable storage location.

5. The method of claim 4, further comprising:
using the simulated non-volatile memory variable storage location to categorize the BIOS variable.

6. The method of claim 1, wherein:
the secure authenticated BIOS interface includes a processor exception handler protocol, the processor exception handling protocol dynamically re initializing an interrupt vector table.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed BIOS, the distributed BIOS including a BIOS component and a BIOS variable, the BIOS variable being stored within a firmware variable non-volatile memory store;
instantiating a firmware variable transaction; and,
authenticating, via a secure authenticated BIOS interface, the firmware variable transaction.

8. The system of claim 7, wherein:
the authenticating is performed by an embedded controller, the embedded controller providing the information handing system with a root of trust for the firmware variable transaction.

9. The system of claim 7, wherein:
the secure authenticated BIOS interface includes a trusted shadowing protocol, the trusted shadowing protocol implementing a device path based authorization for the firmware variable transaction.

10. The system of claim 7, wherein the instructions executable by the processor are further configured for:
generating a simulated non-volatile memory variable storage location.

11. The system of claim 10, wherein the instructions executable by the processor are further configured for:
using the simulated non-volatile memory variable storage location to categorize the BIOS variable.

12. The system of claim 7, wherein:
the secure authenticated BIOS interface includes a processor exception handler protocol, the processor exception handling protocol dynamically re initializing an interrupt vector table.

13. A non-transitory, computer-readable storage medium embodying computer program code, the computer program code comprising computer executable instructions configured for:
providing an information handling system with a distributed BIOS, the distributed BIOS including a BIOS component and a BIOS variable, the BIOS variable being stored within a firmware variable non-volatile memory store;
instantiating a firmware variable transaction; and,
authenticating, via a secure authenticated BIOS interface, the firmware variable transaction.

14. The non-transitory, computer-readable storage medium of claim 13, wherein:
the authenticating is performed by an embedded controller, the embedded controller providing the information handing system with a root of trust for the firmware variable transaction.

15. The non-transitory, computer-readable storage medium of claim 13, wherein:
the secure authenticated BIOS interface includes a trusted shadowing protocol, the trusted shadowing protocol implementing a device path based authorization for the firmware variable transaction.

16. The non-transitory, computer-readable storage medium of claim 13, wherein the computer executable instructions are further configured for:
generating a simulated non-volatile memory variable storage location.

17. The non-transitory, computer-readable storage medium of claim 16, wherein the computer executable instructions are further configured for:
using the simulated non-volatile memory variable storage location to categorize the BIOS variable.

18. The non-transitory, computer-readable storage medium of claim 17, wherein:
the secure authenticated BIOS interface includes a processor exception handler protocol, the processor exception handling protocol dynamically re initializing an interrupt vector table.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
